(19) United States
(12) Patent Application Publication
(10) Pub. No.: US 2012/0272428 A1
(43) Pub. Date: Nov. 1, 2012

(54) User Wearable Animal Decoy

(76) Inventor: Mark Renner, Bozeman, MT (US)

(21) Appl. No.: 13/096,074

(22) Filed: Apr. 28, 2011

(51) Int. Cl. A41D 13/00; A42B 1/24; A01M 31/06; A42B 1/00

(52) U.S. Cl. 2/69; 2/206; 43/2

(57) ABSTRACT

A user wearable animal decoy, to: provide the user with a wearable decoy, allow the user to move effortlessly through the game territory with ease and little difficulty, attract selected game to the user, and not interfere with the user's movement during operation of any equipment that is being operated by the user. There may be a decoy hat, designed to be worn by the user on their head, having a cavity, formed within the decoy hat, designed and shaped for placement of a top portion of the users head therein; a pair of horns, removably coupled to a top section of the decoy hat; a coloration patch, removably coupled to the decoy hat. There may be a decoy neck, positionally located proximate to the decoy hat, designed to be worn by the user to cover at least a portion of the face of the user to resemble a neck of the animal. There may be a decoy body, positionally located proximate to the decoy neck and separated from the decoy hat, designed to be worn by the user to cover at least a portion of the body of the user to resemble a body section of the animal.

### BACKGROUND OF THE INVENTION

1. Field of the Invention

The present invention relates to decoys to attract desired animals to a user. More particular, there is a decoy that has been developed to: provide the user with a wearable decoy, allow the user to move effortlessly through the game territory with ease and little difficulty, attract selected game to the user, and not interfere with the user's movement during operation of any equipment that is being operated by the user.

2. Description of the Related Art

In the related art, it has been known to use various hunting methods and systems that are directed to lure the game proximate to the hunter. Some improvements have been made in the field. Examples of prior art references that are related to the present invention are described below, and the supported teachings of each reference are incorporated by reference herein:

U.S. Pat. No. 7,017,196, entitled: HAT DEVICE, issued Mar. 28, 2006 to Sterling, et al., discloses hat device configured to visually simulate a vehicle tire. The hat device is configured so that the visually simulated tire is worn transversely relative to a user's head.

U.S. Pat. No. 7,086,193, entitled DEER DECOY WITH DETACHABLE MOVABLE HEAD, issued Aug. 8, 2006 to Hurst, discloses a highly portable, motorized deer decoy uses a head motor to rotate the head of the decoy approximately 125 degrees, simulating the movement of the head of a live deer. The head and front torso of the deer decoy each have plates attached. The head plate can be attached or removed from a middle plate. The head motor is attached to the lower plate and rotates the middle plate. The head portion and legs of the deer decoy may be completely detached from the body. The detachability of the head and legs provides a compact and highly mobile deer decoy that may be readily transported, assembled and operated. The decoy also has another bleat motor that enables the hunter to simulate the bleating of a deer in the woods. The movement of the deer's head and the operation of the bleating device may be remotely controlled by a hand-held remotely controlled signaling device.

U.S. Pat. No. 7,114,198, entitled HELMET ATTACHMENT, issued Oct. 3, 2006 to Hsieh, et al., discloses a helmet attachment includes a structure representing at least one of an animal feature, an insect feature, a historical helmet feature, mythical creature part, and a vehicle feature. The helmet attachment further includes an attachment mechanism for securing the structure to a surface of a helmet.

U.S. Design Pat. No. D179,967, HELMET, issued Apr. 2, 1957 to Erickson, discloses a helmet with horns.

U.S. Design Pat. No. 216,769, BEAR HAT, issued Mar. 10. 1970 to Hicks, discloses a hat device configured to visually simulate a bear.

U.S. Design Pat. No. D247,333, NOVELTY HAT, issued Feb. 28, 1978 to Dame, discloses a hat device configured to visually simulate an alligator.

U.S. Design Pat. No. D262,495, HAT OR THE LIKE, issued Jan. 5, 1982, to Hatten, discloses a hat device configured to visually simulate a bird.

U.S. Design Pat. No. D370,972, DECOY FOR WHITETAIL DEER, issued Jun. 18, 1996 to Dutton, discloses an ornamental design for decoy for whitetail deer.

U.S. Design Pat. No. D399,337, DESIGN FOR A CAP, issued Oct. 13, 1998 to Saunders, et al., discloses a cap configured with horns protruding out each side of the cap.

U.S. Design Pat. No. D411,238, MANTA RAY HAT, issued Jun. 22, 1999 to Cornish, discloses hat device configured to visually simulate a manta ray.

U.S. Design Pat. No. D411,239, HORSE HEAD HAT, issued Jun. 22, 1999 to Jack, discloses a hat device configured to visually simulate a horse head.

U.S. Pat. No. 5,708,983, entitled INFLATABLE CHEESE WEDGE HAT, issued Jan. 20, 1998 to Cross, et al., discloses an inflatable hat provides a concave pocket constructed of flexible material that opens to freely receive the user's head in the manner of a conventional hat by virtue of supports resisting the outward extension of the pocket when the hat is inflated. In one embodiment, the pocket is a cylindrical tube extending between parallel walls of the hat structure. A bowing in of the tube provides varying sizes of hat openings depending on the amount of inflation to provide a comfortable fit to different users.

U.S. Pat. No. 7,017,196, entitled HAT DEVICE, issued Mar. 28, 2006 to Sterling, et al., discloses an inflatable hat provides a concave pocket constructed of flexible material that opens to freely receive the user's head in the manner of a conventional hat by virtue of supports resisting the outward extension of the pocket when the hat is inflated. In one embodiment, the pocket is a cylindrical tube extending between parallel walls of the hat structure. A bowing in of the tube provides varying sizes of hat openings depending on the amount of inflation to provide a comfortable fit to different users.

U.S. Pat. No. 6,256,799, entitled HELMET COVERS, issued Jul. 10, 2001 to McGlasson, et al., discloses a helmet cover is provided for covering a helmet having a rigid shell with an outer surface, and inner surface and an outer edge. A padding material is also coupled to the inner surface. The cover comprises a flexible cover body that is adapted to be removably disposed about the outer surface of the shell. The flexible body has an outer periphery and an elastic material that is disposed near the outer periphery. Further, the body is shaped that it is adapted to be folded over the outer edge of the shell such that the elastic material is positioned generally adjacent to the inner surface of the shell.

U.S. Pat. No. 6,848,122, entitled ECORATIVE REMOVABLE HELMET COVER FOR SKI, SHOWBOARD, SKATEBOARD AND VARIOUS TYPES OF HELMETS, issued Feb. 1, 2005 to Meeds, discloses a decorative removable helmet cover adapted for receipt over the top of a hard plastic exterior surface of a ski helmet, a snowboard helmet, a skateboard helmet, a bicycle helmet or hardhat for providing a unique appearance to the helmet or the hardhat. The removable helmet cover includes a flexible dome-shaped soft cloth exterior surface disposed on top of a flexible dome-shaped soft cloth interior liner. The interior liner is adapted for receipt over and conform to an exterior surface of the helmet. A lower circumference of the exterior surface is attached to a hollow elastic band. Also, a lower circumference of the interior liner is attached to the hollow elastic band. Disposed inside the hollow elastic band is an elastic tie. Opposite ends of the tie extend outwardly from an opening in a rear portion of the elastic band. The opposite ends of the tie are received through a tie lock and are attached to a tie pull. The tip pull and tie lock are used for pulling on the tie and tightening it around sides of the helmet.

U.S. Pat. No. 4,218,780, entitled COSTUME HEADDRESSES, issued Aug. 26, 1980 to Growe, et al., discloses a headdress or headcovering which includes an inflatable, helmet portion for positioning and retain the same upon one's head and an inflatable caricature portion attached to the helmet portion thereof. The helmet portion including a formable, resilient portion of sheet material to conform to the head of the user and having an inflatable peripheral portion to surround the lower edge thereof and hold the same about the user's head, the inflatable caricature portion including an attachment portion for attaching the same to the helmet portion and including a separate inflation unit for the inflatability of the same.

U.S. Pat. No. 4,268,918, entitled NOVELTY CAP, issued May 26, 1981 to Lee, discloses a novelty cap suitable for use as a head covering is provided with the appearance of one of a family of animals. The caps are all provided with at least one movable animal feature which a wearer of the cap may selectively operate by pulling on string connectors looped underneath the cap wearer's chin.

U.S. Pat. No. 4,339,887, entitled DECOY, MOLD AND METHOD OF CONSTRUCTION, issued Jul. 20, 1982 to Streeter, discloses a life-like decoy for hunting purposes which includes a molded body portion having an internal cavity and a removable head and legs which can be stored in the cavity during transportation of the decoy. A mold for shaping a decoy which includes a pair of body segments with a cooperating cavity segment, and a pair of registering head segments for molding the decoy body and head, respectively, with the internal cavity provided in the body mold. A procedure and technique for constructing the body and cavity segments of the decoy which includes carving a mold model in selected detail to a desired shape and shaping the body and head segments and the cavity portion of the mold over the model in multiple layers of polymerized material and fiberglass mat to create a mold of exceptional strength, detail and release characteristics which can be used to form and shape multiple decoys without failure or warp.

U.S. Pat. No. 4,545,313, entitled METHOD FOR MAKING A HAT, issued Oct. 8, 1985 to Chiang, discloses a method for making a hat or visor with a three dimensional figure incorporated into the fabrication of the hat. The figure is sewn into the hat back and becomes integrated as part of the hat so that the figure is securely held erect above the bill of the hat.

U.S. Pat. No. 4,773,178, entitled DEER DECOY, issued Sep. 27, 1988 to Marek, discloses a portable apparatus is provided for hunters to be used to attract deer. The apparatus is comprised of an inflatable structure which, when inflated, has the contour and surface appearance of a deer. The inflated deer is anchored in a stable upright position by stakes which are driven into the ground through flaps attached to the feet of the deer. A scent dispenser is associated with the rear extremity of the deer, and dispenses an odor which attracts male deer.

U.S. Pat. No. 4,928,418, entitled EXPANDABLE GOOSE DECOY, issued May 29, 1990 to Stelly, discloses an expandable goose decoy having a wire frame and an expandable body envelope. The body envelope is expanded by rotating upon a fully enclosed rigid stationary loop on the wire frame.

U.S. Pat. No. 4,991,235, entitled NOVELTY HAT, issued Feb. 12, 1991 to Warner, discloses a hat shell formed in the shape of a three-dimensional object, such as an automobile, a boat, or a motorcycle. Within the hat shell is a hatband which is detachably connected by interlocking hooks and eyes mounted on the hatband and on the interior walls of the hat shell. The headband is adjustable in size so as to accommodate various head sizes.

U.S. Pat. No. 5,522,168, entitled GAME DECOY, issued Jun. 4, 1996 to Friddle, discloses a decoy having a collapsible molded head in place on a pliable backing sheet. The head and sheet components are shaped to simulate a game animal viewed in frontal elevation. A fabric cover encloses the backing member with an opening permitting the head to be attached in place on the backing member. The cover is shaped and colored to simulate an animal chest. An opening in the cover enables sighting through the decoy as well as arrow passage.

U.S. Pat. No. 5,791,081, entitled DEER DECOY, issued Aug. 11, 1998 to Turner, et al., discloses a new deer decoy for attracting an animal such as a deer into close proximity of a waiting hunter. The inventive device includes a deer shaped main body member including a head portion and a rear portion. A pair of ear members are rotatably mounted to the head portion and are rotatable between a friendly position and a challenging position. A tail member is pivotally mounted to the rear portion and is pivotable between a first position and a second position to simulate the tail movement of a live animal.

U.S. Pat. No. 6,021,594, entitled BIG GAME DECOY, issued Feb. 8, 2000 to Krueger, discloses a four-legged female wild game decoy for attracting like male game on the ground includes a vertical support, which may simulate a forward leg, mountable to the ground. A body is pivotally mounted to the vertical support and is appropriately biased in a substantially upright horizontal posture. The body has a rear hip portion supporting a pivotally mounted tail and a foldable rear leg suspended therefrom. A body posture adjustment mechanism is provided for raising the tail and lowering the hip portion to simulate a squatting urination posture for the game decoy.

U.S. Pat. No. 6,389,604, entitled INFLATABLE HEADWEAR, issued May 21, 2002 to Day, discloses an article of decorative headwear comprises first and second flexible, generally gas-impermeable material. Each of the first and second sheets has a peripheral edge portion. The first and second sheets are sealed to one another at their respective peripheral edge portions to define an inflatable volume between the first and second sheets. The first and second sheets are shaped to define a primary inflatable portion and a pair of inflatable leg portions that extend from the primary inflatable portion. The inflatable leg portions are spaced from one another to define a head-receiving space between them, which is adapted for receiving a wearer's head. The inflatable leg portions are adapted for engagement with side portions of the wearer's head in a manner to retain the headwear on the wearer's head when the inflatable leg portions are inflated.

U.S. Pat. No. 6,519,891, entitled INFLATABLE DECOY, issued Feb. 18, 2003 to Fulcher, discloses an inflatable decoy is disclosed having an outer cover forming a cavity. The outer cover is fabricated from a thin, flexible, material. The exterior of the outer cover is imprinted with an actual life-sized photograph of a game animal. Structure is disposed in the cavity for expanding the decoy to simulate life-size game. The decoy is mounted for wind-aided movement.

U.S. Pat. No. 6,874,166, entitled NOVELTY HAT, issued Apr. 5, 2005 to Clary, discloses a novelty hat includes a headband with first and second end. The headband generally defines an annular shape and includes velcro closure strips on the ends thereof. At least one of the velcro strips also secures to the headband. A liner and exterior shaped figure extend upwardly from the headband. Stuffing is disposed between the liner and the figure such that the figure forms the shape of an animal head, sports logo or mascot.

U.S. Pat. No. 6,925,745, entitled COLLAPSIBLE BLIND, issued Aug. 9, 2005 to Alessi, discloses a blind or device for concealing the presence of a person, which include a flexible sheet of material, the sheet of material having a first side having an image of an animal such as a domesticated animal. The flexible sheet of material further having a perimeter, at least most of the perimeter being supported by a frame. The frame will be made from resilient sections that connect to one another and pull most of the flexible sheet of material taut. The blind may further include a handle mounted within the perimeter of the flexible sheet. The handle will cooperate with the frame to allow a user to support the entire weight of the blind while supporting the blind in front of the user's body and concealing the user's body behind the blind.

The inventions heretofore known suffer from a number of disadvantages. There does not exist a method, system or apparatus that is designed to: provide the user with a wearable decoy, allow the user to move effortlessly through the game territory with ease and little difficulty, attract selected game to the user, and not interfere with the user's movement during operation of any equipment that is being operated by the user.

What is needed is a method, system or apparatus that is designed to: provide the user with a wearable decoy, allow the user to move effortlessly through the game territory with ease and little difficulty, attract selected game to the user, and not interfere with the user's movement during operation of any equipment that is being operated by the user.

### SUMMARY OF THE INVENTION

The present invention has been developed in response to the present state of the art, and in particular, in response to the problems and needs in the art that have not yet been fully solved by currently available decoy designs. Accordingly, the present invention has been developed to: provide the user with a wearable decoy, allow the user to move effortlessly through the game territory with ease and little difficulty, attract selected game to the user, and not interfere with the user's movement during operation of any equipment that is being operated by the user.

There is in one embodiment, provided a user wearable animal decoy. There may be a decoy hat, designed to be worn by the user on their head, having a cavity, formed within the decoy hat, designed and shaped for placement of a top portion of the users head therein; a pair of horns, removably coupled to a top section of the decoy hat; a coloration patch, removably coupled to the decoy hat. There may be a decoy neck, positionally located proximate to the decoy hat, designed to be worn by the user to cover at least a portion of the face of the user to resemble a neck of the animal. There may be a decoy body, positionally located proximate to the decoy neck and separated from the decoy hat, designed to be worn by the user to cover at least a portion of the body of the user to resemble a body section of the animal.

Reference throughout this specification to features, advantages, or similar language that does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a schematic side view of the decoy headgear.

FIG. 2 illustrates a schematic front view of the decoy headgear;

FIG. 3 illustrates a schematic back view of the decoy headgear;

FIG. 4 illustrates a schematic top view of the decoy headgear;

FIG. 5 illustrates a schematic bottom view of the decoy headgear;

FIG. 6 illustrates a schematic bottom view of the decoy headgear with a baseball cap attached to the headgear;

FIG. 7 illustrates a schematic side view of the decoy headgear with a baseball cap attached to the headgear;

FIG. 8 illustrates a schematic view of the decoy headgear being worn by a person, in combination with the decoy shirt also being worn by a person;

FIG. 9 illustrates a schematic side view of an embodiment of the invention with a face and neck decoy feature attached to the bottom side of the decoy headgear;

FIG. 10 illustrates a schematic side view of an embodiment of the invention with the horns removed and a side gender coloration patch removed from the decoy headgear;

FIG. 11 illustrates a schematic side view of an embodiment of the invention, displaying a mesh sock over mounted over the decoy headgear.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of and “consisting essentially of”

As used herein, “and,” and grammatical equivalents thereof is intended to be inclusive or open-ended that does not mean that all of the elements in the list must be included. Specifically, the term “and” can be viewed as an equivalent of the commonly used phrase “and/or”, which is intended to create an unrestricted list of elements that may or may not require all of the elements to be included therein.

The present invention has been developed in response to the present state of the art, and in particular, in one embodiment, in response to the problems and needs in the art that have not yet been fully solved. Accordingly, the present invention has been developed to provide a user a wearable decoy allowing the user to approach a desired animal without detrimentally alerting the game of the presence of the user. Additionally, the wearable decoy allows the user to move effortlessly through the game territory with ease and little difficulty. Moreover, the wearable decoy is intended to actually attract selected game to the user while being worn by the freely moving user. Similarly, the wearable decoy is designed to not interfere with the user's movement during operation of any equipment that is being operated by the user.

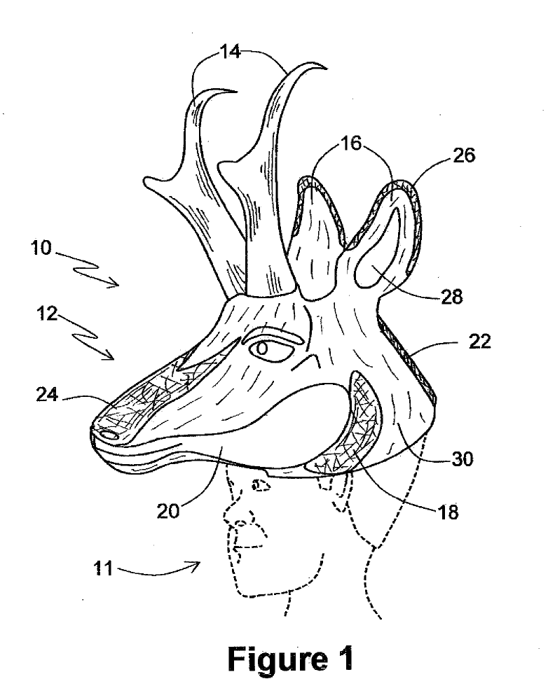

FIG. 1 illustrates a side view of one embodiment of a wearable decoy 10 for users 11. In particular, there is specifically illustrated a wearable decoy 10 in the form of an antelope head that is wearable as a hat on a user 11. The decoy hat 10 has standard antelope features. There is a head portion 12 that has representable removable horns 14, a pair of ears 16, a male dark patch 18, a species white patch 20, a dark species main 22, a dark nose patch 24, a dark ear trim patch 26, a white inner ear patch 28, and a standard tan colored main body section 30.

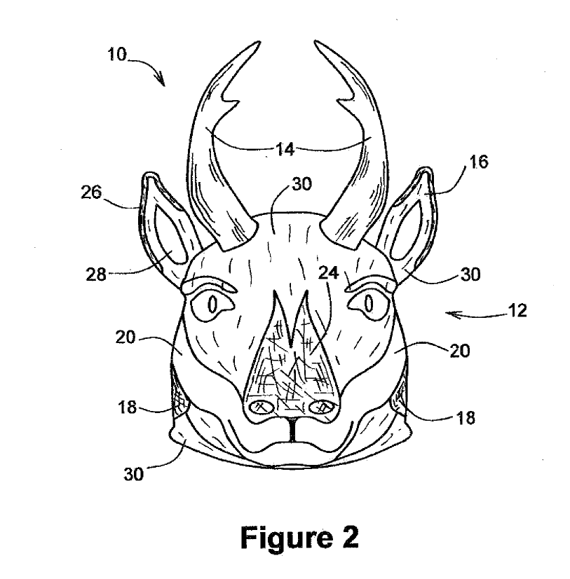

FIG. 2 illustrates a frontal view of one embodiment of the wearable decoy 10 for users 11. There is shown the positioning of the various features of the decoy 10 that are indicative of a real life game species in the form of the antelope form FIG. 1.

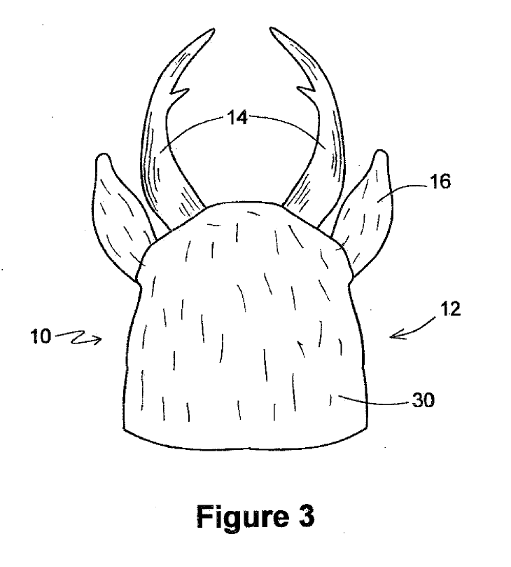

FIG. 3 illustrates a rear view of one embodiment of the wearable decoy 10 for users 11. There is shown the positioning of the various features of the decoy 10 that are indicative of a real life game species in the form of the antelope form FIGS. 1 and 2.

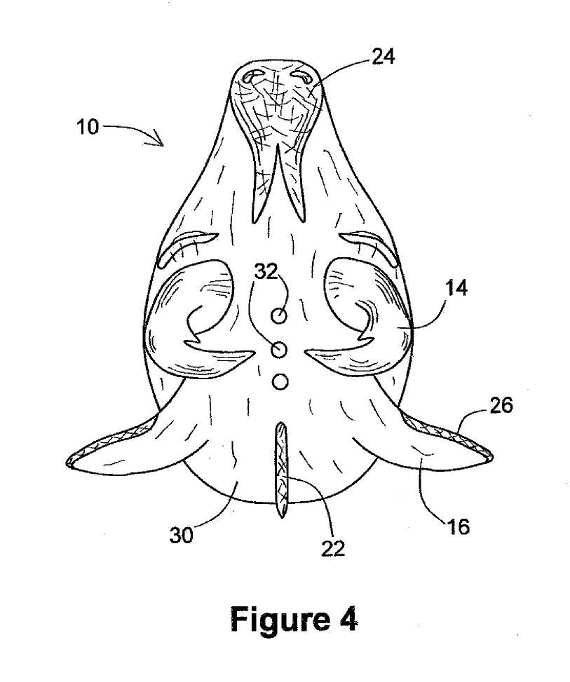

FIG. 4 illustrates a top view of one embodiment of the wearable decoy 10 for users 11. There is shown the positioning of the various features of the decoy 10 that are indicative of a real life game species in the form of the antelope form FIGS. 1, 2 and 3. In addition, there is illustrated positioning of vents or holes 32 to allow for ventilation of heat from within the decoy hat 10.

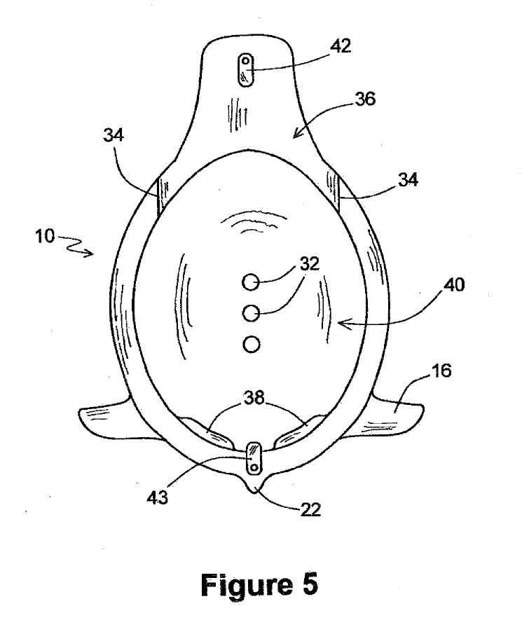

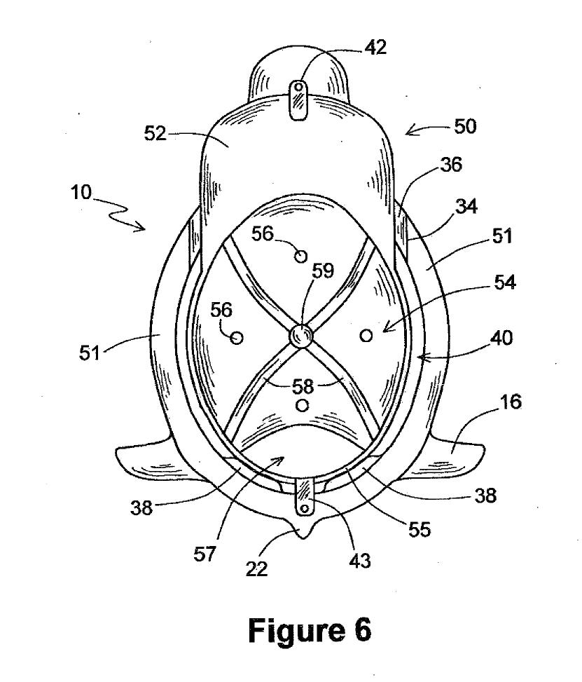

FIG. 5 illustrated a bottom view of one embodiment of the wearable decoy 10 for users 11 and FIG. 6 illustrated the same view with the addition of a baseball cap 50 respectively fitted therein. In particular, there is shown the positioning of the various features of the decoy 10 that are indicative of a real life game species in the form of the antelope form FIG. 1-4. Additionally, there is shown the inside portion of the decoy 10 where there is a cavity 40 for positioning a head of a user 11. There are also illustrated a front hat clip 42 and a rear hat clip 43, designed to be coupled to the brim 52 and back strap 55 of the baseball cap 50. Whereby, the front attachment 42 may be a clip like a clothes pin or spring type mechanism like a paper clip and the like. Similarly, the back attachment 43 may be a strap that could wrap around the hat strap 55. There are inside cavity spacers 38 to, for one use, hold the user head 11 away from the sides of the wall of the cavity 40. There is also, recessed section 36 defined by side walls 34, designed to retain a portion of the baseball cap brim 52 in the illustrated position. The cavity may be a recessed portion of the circular bottom rim 51 of the decoy hat 10 as illustrated. There is also illustrated hat venting holes 56, hat fabric ribs 58, back hat size adjustment opening 57, and hat top holding button 59, which are all known in the art of baseball hat manufacturing.

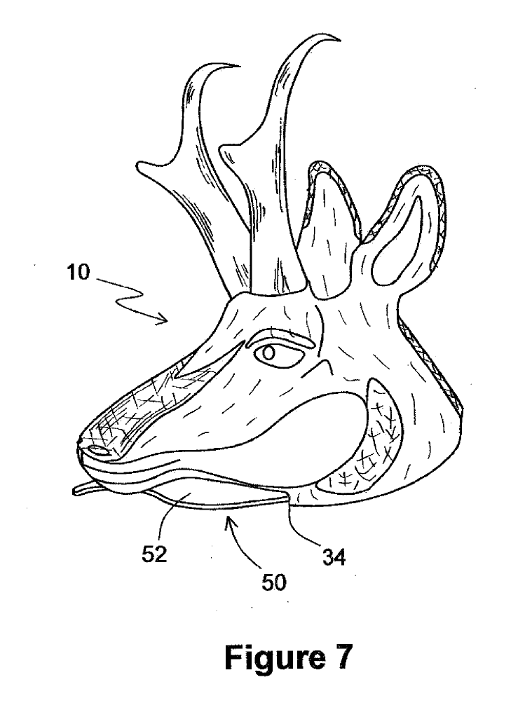

FIG. 7 is a side view from FIG. 1 of one embodiment of the invention. In addition to the previously illustrated features, there is shown the fitting of the baseball hat 50 with the bill 52 fitted within the cavity 36 and held in place by the side walls 34 defining the cavity formed within the decoy bottom rim 51.

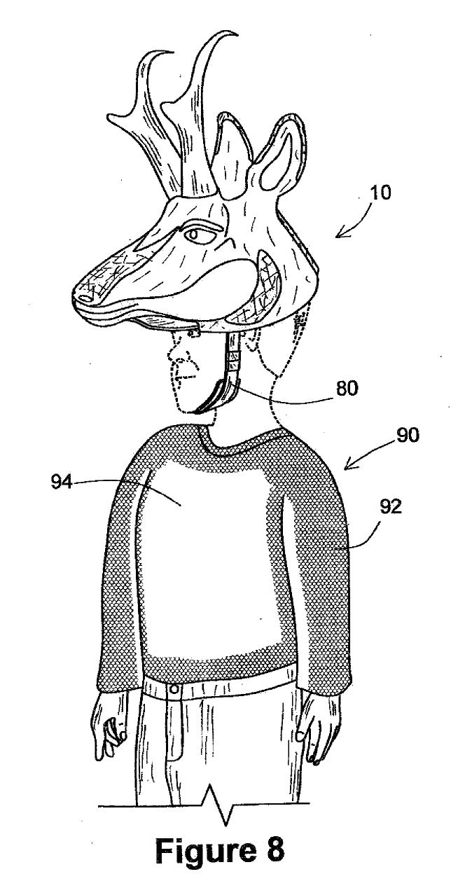

FIG. 8 is an isometric view of the decoy 10 as worn by a user 11. In particular, in addition to the previous features, there is illustrated in this embodiment a chin strap device 80, coupled to the decoy hat 10, and designed to adjustably retain the decoy hat 10 securely to the user's head 11. Additionally, there is illustrated an additional embodiment where the user 11 wears a matching species coloration shirt 90. The shirt 90 would include darker tan sections 92, and lighter patches 94 that are positioned specifically to match the species of the animal head being warn.

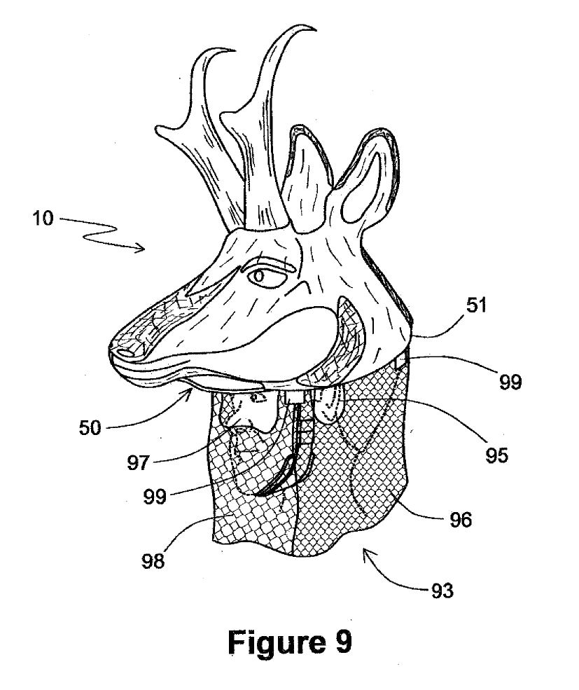

FIG. 9 is a side view of the decoy hat 10 as illustrated in previous views. In addition to the previously described features, there is added an animal neck portion 93. The neck portion 93 is coupled to the decoy hat 10 by couplings 99, positioned around the lower rim 51 region of the decoy 10. The neck portion 93, like other portions of the decoy 10, has matching coloration to the decoy species; there is a lighter section 98 in the front and a darker, tan, section 96. There may also be user ear openings 95, and eye openings 97 positioned therein as illustrated.

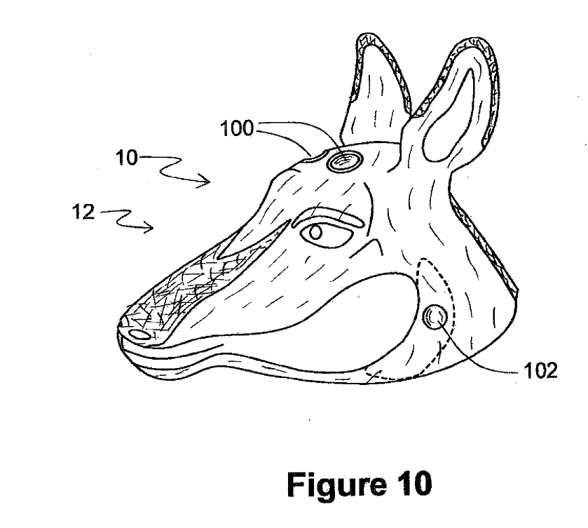

FIG. 10 is another embodiment of a modified side view of the decoy hat 10 of FIG. 1. In addition to the previous features, there are horn attachment elements 100, coupled to the decoy head 12 in appropriate respective positions, and designed to releasably couple the horns 14 thereto. This feature allows the user 11 to use a dual purpose decoy hat 10 that is in the form of the male are female appearance of the species, which are typically distinguished by the existence of horns. Additionally, there may also be coloration patch attachment elements 102, coupled to the decoy head 11, and designed to releasably retain coloration patches in the appropriate male or female identification locations. Specifically, the illustrated removed dark patch is representative of the male antelope, and has thus been removed to further display the female of the antelope species. Therefore, the decoy hat 10 is now able to be easily converted between the male and female heads to allow the user to stalk the respective animals under different appearances.

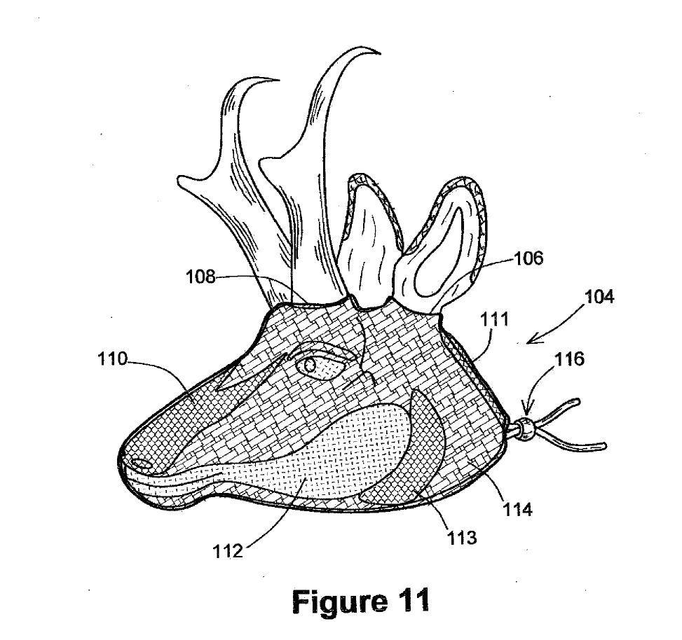

Referring now to FIG. 11, there is illustrated a side view of another embodiment of the invention. In particular, it is known that most, if not all, animals do not see actual color, but do see shades of light. Thus, it is of particular concern that the described invention to this point is described to make the decoy in the most exact color to the animal species. This presents a favorable decoy during short range sporting seasons, like bow hunting. However, this situation would be catastrophic for use during long range harvesting seasons, like rifle hunting. During those long range seasons, sportsperson are required to wear a certain ease to see coloration, usually in the shades of blaze orange visual spectrum. Therefore, the presently illustrated features of FIG. 11 include the added feature of placing a blaze orange covering 104 that conformably fits over the decoy head 10. The blaze orange covering 104 may have ear holes 106, and horn holes 108. There may be a cinching mechanism 116 that has a typical rope that fits around the decoy hat rim 51 to pull the covering tight thereto. Additionally, there may be darker blaze orange shade patches 113, 110, and 111, lighter blaze orange patches 112, and intermediate blaze orange patches 114. Thus, the desired tracked animals will see the same shades of patches as the decoy hat without the blaze orange covering. However, a human will clearly see the designated safe blaze orange color on the top of a user from well over a mile away.

### Variations of the Illustrated Embodiments

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated embodiments illustrate only one prescribed design and shape of the various elements, steps and features of the illustrated embodiments, one skilled in the art could easily design any number of changes for executing the essential features and elements hereto.

Specifically, there is illustrated an antelope decoy design throughout this specification and associated drawings. Yet, one skilled in the art of animals and decoys would find it rather parochial, after reading this specification, to design any number of decoy animal designs. For example, the decoy could be made in the form of an elk, mule deer, white tail deer, moose, mountain goat, mountain sheep, caribou, walrus, seal, coyote, wolf, beaver, crockadile, alligator, bear, musk ox, lion, tiger, kangaroo, elephant, panda bear, hippo, kudu, wildebeest, etc. Although, it is noted that one should be careful when wearing certain decoys to not be mistaken for a prey by predators in certain geographic locations.

Additionally, there is illustrated a single way for users to make shape of the decoy. Whereby, each manufacture may have many different designs. For example, the decoy may be a solid core device made of a light foam material. Yet, it may be that the decoy is made of a air inflated ball that allows a user to blow it up and deflate it at will and wad it up and put it in his pocket like a balloon.

Additionally, the specification discusses the use of a blaze orange sleeve that fits over the decoy but not the ears or horns. Whereby, the sleeve 104 could easily be designed to fit over those projections, or even have separate smaller sleeves designed to fit only over the ears and horns, which sleeves are then attached to the main head sleeve in any known attachment means like snaps, zippers and such.

Further, although only one way of attaching the decoy hat to the user is illustrated, like using the baseball hat, one skilled in the art would understand that any known hat wearing method is usable. Specifically, the baseball hat may be eliminated completely, and the decoy hat can have inner and attachment designs like any other known head gear, like motorcycle helmets, or army helmets. The decoy hat may include any known hat securing device to retain the decoy hat to the user head during the often active movement of a stalker through brush and woods. In other words, one may only look to military and motor cycle helmet designs to find a plethora of releasably securable designs that may be implemented therein.

It is further noted that the present illustrated embodiments discuss the use of a baseball cap bill cavity 36, wherein a skilled artisan would understand that there are many variations to a fitting a baseball hat to the described decoy hat. For example, one would consider it to be duplicative and obvious variations to discuss that the baseball hat could be secured to the decoy hat by way of fasteners, clips, straps, hooks, latches etc.

Further, although the decoy neck is illustrated to be attached to the decoy hat, and to be hanging downward therefrom, there are other embodiments and variations that are equally workable. For example, the neck section could be a full head covering like a stocking hat that covers the face and neck region of a user. In this design the neck section is not attached to the decoy head at all, and is independently worn by the user. In other words, this may appear to be a bank robber wearing a ski mask or stocking covering the entire head, or a portion thereof. Although, it is not needed to have a tight fit to the user, and may have a completely loose fit.

It is also contemplated to have the neck section in any form that is known or yet to be developed to enable a user to cover the user's facial features and represent to the stalked animal that there is no human in the decoy.

It is also illustrated many features of different embodiments of the invention that are purely embodied in the figures, attached hereto. Specifically, the special features are clearly illustrated and are not described in detail, since one skilled in the art of designing such illustrated inventions would clearly understand these features have an infinite ability to be adjusted. For example, the thickness and proportions of the various parts of the decoy hat are not discussed. The materials used for the shirts and animal neck equipments are infinite in design and material. It may even be possible to have the neck feature to be permanently attached to the decoy hat. The neck feature may also only be designed to be partially surrounding the user, whereby the back section may not exist and be open to allow the user to have open space, since the decoy is primarily designed to be facing the animal or at least be side ways thereto.

Although the illustrated embodiment(s) describe the primary use of a decoy hat, the other parts of the decoy may be equally important to allow a user to approach desired animals. For example, a user may only use the decoy hat as illustrated. However, as illustrated the inclusion of a neck section can be equally beneficial. Additionally, the use of a body decoy section, like illustrated by the use of a shirt with the proper coloration markings. It is also contemplated to include pants in the overall decoy design. For example, the fauna environment may require a more complete simulation of the animal appearance, since the legs could be visible to approached animals.

Additionally, in other embodiments, it is contemplated to create a more complete wearable decoy, whereby a back end of a four legged animal may be included in the overall decoy design. This back side feature may be attached to the user in may known fashion.

Thus, while the present illustrated embodiment(s) has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is desired to be claimed as Letters Patent under the United States Constitution, Article 1, section 8, clause 8, “To promote the progress of the science and useful arts, by securing for limited times to authors and inventors the exclusive right to their respective writings and discoveries”, is set forth herein after:

1. A user wearable animal decoy, to: provide the user with a wearable decoy, allow the user to move effortlessly through the game territory with ease and little difficulty, attract selected game to the user, and not interfere with the user's movement during operation of any equipment that is being operated by the user, comprising:
a) a decoy hat, designed to be worn by the user on their head, having:
i) a cavity, formed within the decoy hat, designed and shaped for placement of a top portion of the users head therein;
ii) a pair of horns, removably coupled to a top section of the decoy hat; and
iii) a coloration patch, removably coupled to the decoy hat;
b) a decoy neck, positionally located proximate to the decoy hat, designed to be worn by the user to cover at least a portion of the face of the user to resemble a neck of the animal; and
c) a decoy body, positionally located proximate to the decoy neck and separated from the decoy hat, designed to be worn by the user to cover at least a portion of the body of the user to resemble a body section of the animal.

2. A user wearable animal decoy, to: provide the user with a wearable decoy, allow the user to move effortlessly through the game territory with ease and little difficulty, attract selected game to the user, and not interfere with the user's movement during operation of any equipment that is being operated by the user, comprising:
a) a decoy hat, designed to be worn by the user on their head, having:
i) a cavity, formed within the decoy hat, designed and shaped for placement of a top portion of the users head therein;
ii) a pair of horns, removably coupled to a top section of the decoy hat; and
iii) a coloration patch, removably coupled to the decoy hat; and
b) a decoy neck, positionally located proximate to the decoy hat, designed to be worn by the user to cover at least a portion of the face of the user to resemble a neck of the animal.

3. A user wearable animal decoy, to: provide the user with a wearable decoy, allow the user to move effortlessly through the game territory with ease and little difficulty, attract selected game to the user, and not interfere with the user's movement during operation of any equipment that is being operated by the user, comprising a decoy hat, designed to be worn by the user on their head, having:
a) a cavity, formed within the decoy hat, designed and shaped for placement of a top portion of the users head therein;
b) a pair of horns, removably coupled to a top section of the decoy hat; and
c) a coloration patch, removably coupled to the decoy hat.
